(19) United States
(12) Patent Application Publication
(10) Pub. No.: US 2025/0242306 A1
(43) Pub. Date: Jul. 31, 2025

(54) INDOOR AIR CLEANING APPARATUS FOR VEHICLE

(71) Applicants: HYUNDAI MOTOR COMPANY, SEOUL (KR); KIA CORPORATION, SEOUL (KR); SEOYON E-HWA CO, LTD., Anyang-si (KR)

(72) Inventors: Yeong Jae Jang, Seoul (KR); Sang Yeop Lee, Suwon-si (KR); Dae Hee Lee, Incheon (KR); Ji Yun Ha, Suwon-si (KR); Jin Ho Hwang, Cheonan-si (KR); Sung Jin Kim, Sejong-si (KR); Jung Jin Jeon, Siheung-si (KR)

(73) Assignees: HYUNDAI MOTOR COMPANY, SEOUL (KR); KIA CORPORATION, SEOUL (KR); SEOYON E-HWA CO., LTD., ANYANG-SI (KR)

(21) Appl. No.: 18/676,104

(22) Filed: May 28, 2024

(30) Foreign Application Priority Data
Jan. 31, 2024 (KR) 10-2024-0014523

(51) Int. Cl. B01D 53/84; B60H 3/06

(52) U.S. Cl. CPC B01D 53/84; B60H 3/0608; B60H 3/0658; B01D 2257/90; B01D 2257/91; B01D 2259/4566

(57) ABSTRACT

An indoor air cleaning apparatus for a vehicle including an HVAC module configured to regulate the temperature of indoor and outdoor air and provide conditioned air into the interior of the vehicle through a blower, and a moss filter module, connected to the HVAC module, having air-purifying plants planted therein, and configured to allow oxygen generated therein to flow to the HVAC module as indoor air is introduced thereinto through a plurality of intake ports.

### CROSS-REFERENCE TO RELATED APPLICATION

This application claims, under 35 U.S.C. § 119 (a), the benefit of and priority to Korean Patent Application No. 10-2024-0014523, filed on Jan. 31, 2024, the entire contents of which are incorporated herein by reference.

### TECHNICAL FIELD

The present disclosure relates to an indoor air control apparatus for a vehicle. More particularly, it relates to an indoor air control device for a vehicle configured to purify indoor air using a moss filter when operating in recirculation mode.

### BACKGROUND

Recently, as the penetration rate of vehicles, which are a necessity for modern people, has rapidly increased, the time spent inside the vehicle is increasing due to increased traffic.

Generally, because the human body produces energy through breathing, which involves repeating the process of inhaling oxygen and exhaling carbon dioxide, the concentration of carbon dioxide increases as the passengers breathe in the enclosed space, decreasing the amount of required oxygen without the driver or passenger being aware of it.

For this reason, many drivers feel tired or drowsy while driving due to various causes such as long-time driving, accumulated fatigue, increased temperature inside the vehicle, and increased carbon dioxide (CO₂) concentration inside the vehicle, which may be one of the main factors in car accidents.

Particularly, when a vehicle is driven for a long time, air quality deteriorates due to air pollution caused by backflow of exhaust gases into the vehicle and CO₂ produced by the human body, and when the vehicle is kept in an airtight state, such as in winter, the air quality inside the vehicle rapidly deteriorates, and rapidly increased concentration of carbon dioxide may cause the driver and passengers to suffer drowsiness, vomiting, headache, etc.

Furthermore, when the concentration increases, it not only directly harms the health of the driver and passengers, such as causing arrhythmia and decreased consciousness, but also causes drowsiness, which can be a very fatal cause of secondary accidents, such as car accidents due to drowsy driving.

So as to prevent such problems, the government and institutes recommend to reduce pollution inside the vehicle by opening the windows while driving to ventilate the indoor air or operating the air conditioner or ventilation device to circulate the air inside the vehicle. However, in seasons where there is a large difference between outside and inside temperatures, such as summer or winter, it is difficult to constantly ventilate the indoor air while maintaining thermal comfort, and because drivers only focus on the road while driving, it is not easy to check the slowly changing condition of air pollution inside the vehicle, so driving without ventilation is a common reality.

The above information disclosed in this Background section is only for enhancement of understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and an object of the present disclosure is to provide an indoor air control apparatus for a vehicle having a structure in which a moss filter, including in the case thereof an intake port configured to intake indoor air, is connected to a heating, ventilation, and air conditioning (HVAC) system, including a blower, via a separate connection duct, allowing oxygen generated from the moss filter to be effectively delivered to the interior of the vehicle through the blower when operating in a recirculation mode.

In one aspect, the present disclosure provides an indoor air cleaning apparatus for a vehicle, the apparatus including an HVAC module configured to regulate the temperature of indoor and outdoor air and provide conditioned air into the interior of the vehicle through a blower, and a moss filter module, connected to the HVAC module, having air-purifying plants planted therein, and configured to allow oxygen generated therein to flow to the HVAC module as air is introduced thereinto through a plurality of intake ports.

In a preferred embodiment, the moss filter module may be provided with the intake ports configured to be selectively open in a recirculation mode for the HVAC module.

In another preferred embodiment, the moss filter module may include a main body, provided with the plurality of intake ports and having the air-purifying plants disposed thereon, and a plurality of flow guides, mounted in the main body and connected to the intake ports, and configured to guide air generated inside the main body to flow to an inlet of a connection duct provided in the HVAC module.

In still another preferred embodiment, the main body may be provided to be sealed from outside and be made of a transparent material.

In yet another preferred embodiment, the main body may include a growth light emitting diode (LED) member provided in plural number and disposed below an area between blocks of the air-purifying plants, a pole member disposed upright above the growth LED member and configured to transmit light emitted from the growth LED member, and a reflection plate mounted at an upper portion of the pole member and configured to reflect the light transmitted from the pole member.

In still yet another preferred embodiment, the pole member may have a height greater than that of the air-purifying plants.

In a further preferred embodiment, the reflection plate may be mounted to be inclined upwards at the upper portion of the pole member. Here, the reflection plate may be provided as a pair and have inclinations corresponding to each other.

In another further preferred embodiment, the main body may further include a first blocking member coupled to an outer circumferential surface of the pole member, wherein the outer circumferential surface excludes an area where the reflection plate is mounted, and a second blocking member coupled to a rear surface of the reflection plate.

In still another further preferred embodiment, the reflection plate may have a front surface configured to reflect the light transmitted from the pole member. Here, the front surface may have an embossed shape.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view illustrating a state in which a moss filter module is mounted in an indoor air cleaning apparatus for a vehicle according to an embodiment of the present disclosure;

FIG. 2 is a view illustrating the structure of a moss filter module for an indoor air cleaning apparatus for a vehicle according to an embodiment of the present disclosure;

FIG. 3 is a view illustrating a structure to radiate light for an indoor air cleaning apparatus for a vehicle according to an embodiment of the present disclosure;

FIG. 4 is a view illustrating a first blocking member and a second blocking member for an indoor air cleaning apparatus for a vehicle according to an embodiment of the present disclosure; and

FIG. 5 is a view illustrating a reflection plate for an indoor air cleaning apparatus for a vehicle according to an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, preferred embodiments according to the present disclosure will be described in detail with reference to the accompanying drawings.

Advantages and features of the present disclosure, and a method of achieving the same, will be apparent with reference to the embodiments described below in detail in conjunction with the accompanying drawings.

However, the present disclosure may be embodied in many different forms, and should not be construed as being limited to the embodiments set forth herein. Rather, the embodiments are provided so that the present disclosure will be thorough and complete, and will fully convey the scope of the present disclosure to those skilled in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those skilled in the art.

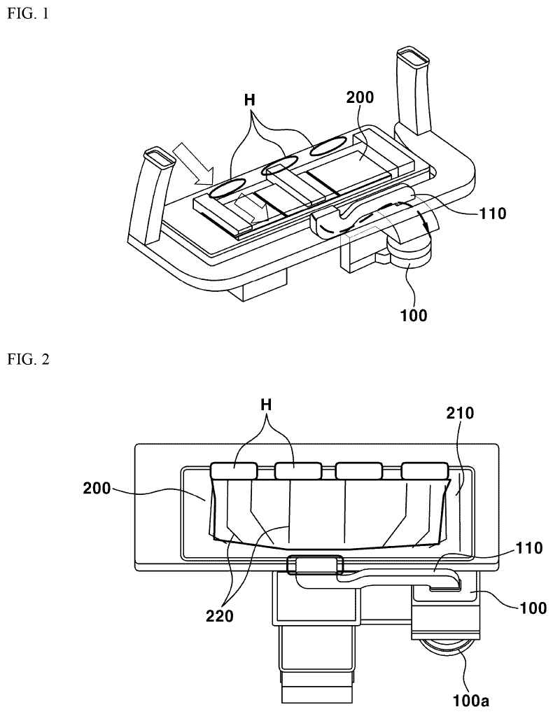

FIG. 1 is a view illustrating a state in which a moss filter module is mounted in an indoor air cleaning apparatus for a vehicle according to an embodiment of the present disclosure, and FIG. 2 is a view illustrating the structure of a moss filter module for an indoor air cleaning apparatus for a vehicle according to an embodiment of the present disclosure.

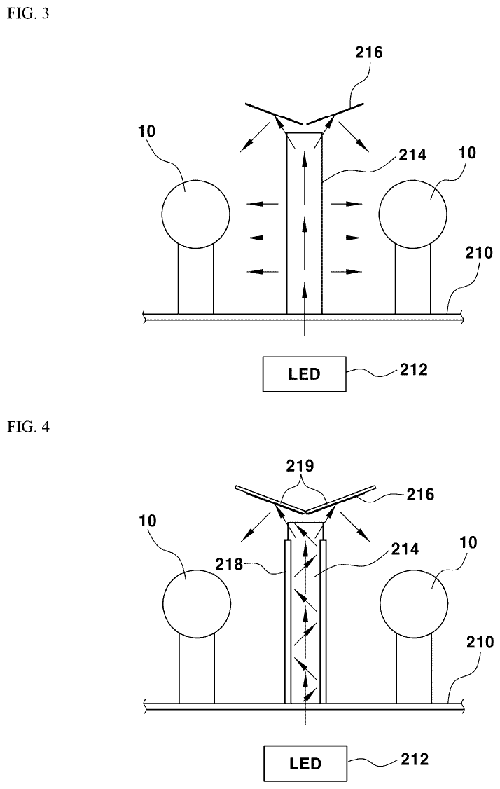

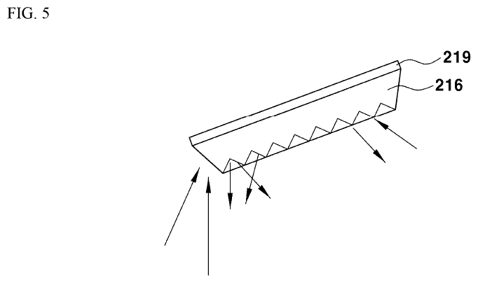

FIG. 3 is a view illustrating a structure to radiate light for an indoor air cleaning apparatus for a vehicle according to an embodiment of the present disclosure, FIG. 4 is a view illustrating a first blocking member and a second blocking member for an indoor air cleaning apparatus for a vehicle according to an embodiment of the present disclosure, and FIG. 5 is a view illustrating a reflection plate for an indoor air cleaning apparatus for a vehicle according to an embodiment of the present disclosure.

Generally, a vehicle is provided with a heating, ventilation, and air conditioning (HVAC) system, also called an air conditioning device, and the HVAC system is configured to heat and cool the air in the vehicle compartment for the comfort of passengers.

The HVAC system may selectively change air supply source. The HVAC system may take in fresh air from outside the vehicle compartment, condition the air, and then circulate the conditioned air into the vehicle compartment. Moreover, the HVAC system may intake mixed air in which outdoor air and indoor air are mixed, condition the mixed air, and then pump the conditioned mixed air into the vehicle compartment.

Here, although not shown on the drawing, the HVAC system may be provided with an intake, generally installed at an engine room side with respect to a dash panel and configured to intake indoor and outdoor air and blow the same into the interior of the vehicle. The intake may be provided with an air filter and a blower 130 within the case of the intake.

In other words, the air filter filters foreign matters contained in the inside and outside air introduced therein through inside and outside air inlets, and the blower serves to intake inside or outside air through the inside and outside air inlets and blow the same to the interior of the vehicle.

Meanwhile, moss, a type of air-purifying plant, produces phytoncide, which may relieve stress, have an antibacterial effect, have a deodorizing effect, have a soothing effect, and improve allergies and skin diseases. Moss has an excellent ability to absorb trace metals, and particularly, has a carbon fixation amount more than 10 times that of ordinary plants, thereby having the ability of generating oxygen more than 10 times that of ordinary plants.

For this reason, allowing oxygen generated during the photosynthetic process of moss to be introduced into the vehicle interior may reduce carbon dioxide concentration inside the vehicle.

However, because in the prior art, it was difficult to efficiently deliver the oxygen generated in this way to the vehicle interior, a separate blower was installed to enable ventilation, and due to the blower additional added to the structure, the structure inevitably became more complex, causing additional costs.

For this reason, this embodiment provides an HVAC module 100 and a moss filter module 200 connected to the HVAC module 100 to solve said problems.

In other words, the moss filter module 200 has planted therein moss, and as illustrated in FIG. 1 and FIG. 2, indoor air is introduced thereinto through a plurality of intake ports H, allowing oxygen generated therein to flow to the HVAC module 100 through a separate connection duct 110.

Specifically, the moss filter module 200 generates oxygen as the moss planted therein photosynthesizes, and the intake ports H are selectively open in a recirculation mode for the HVAC module 100, allowing the oxygen to flow to the HVAC module 100.

Here, the oxygen flew from the moss filter module 200 to the HVAC module 100 may be delivered to the interior of the vehicle through a blower 100a provided in the HVAC module 100, effectively delivering oxygen without having to install a separate blower as in the prior art. Therefore, oxygen may be effectively delivered from the location where the moss filter module 200 is installed in the vehicle interior to a location distant therefrom, thereby reducing indoor carbon dioxide concentration in the recirculation mode.

The moss filter module 200 may include a main body 210 and a flow guide 220.

The main body 210 is provided with the intake ports H configured to be selectively open, and is disposed in the interior of the vehicle, e.g., a rear windshield, by being sealed from outside.

Moreover, because the main body 210 is made of a transparent material, the growing moss planted thereon may photosynthesize using natural light transmitted through the rear windshield.

As illustrated in FIG. 2, a plurality of flow guides 220 are mounted in the main body 210. The flow guide 220 guides air generated inside the main body 210 to move to an inlet of the connection duct 110 provided in the HVAC module 100.

When oxygen is introduced into the main body 210 through the blower 100a, oxygen may flow relatively intensively only into the central area of the main body 210 facing the connection duct 110. For this reason, the main body 210 has an inner side from which the plurality of flow guides 220 protrudes, allowing oxygen generated inside the main body 210 to flow evenly towards the HVAC module 100 through the connection duct 110.

More preferably, flow guides 220 each extending from corresponding one of intake ports H disposed at the opposite sides of the main body 210, respectively, may be curved to face the inlet of the connection duct 110 to minimize oxygen blocked from being introduced into the connection duct 110 (see FIG. 2).

Meanwhile, the main body 210 includes, as illustrated in FIG. 3, a growth LED member 212, a pole member 214, and a reflection plate 216.

The growth LED member 212 is provided in plural number and is disposed below an area between blocks of moss 10. More preferably, the growth LED members 212 may be provided at predetermined intervals to cover all of the moss 10, depending on the arrangement and distribution of the blocks of moss 10 in the main body 210.

Normally, when growing a plant in a vehicle, the growth LED member 212 is installed at a higher position than the plant to provide light radiation, and in this case, a pillar should be installed to mount the growth LED member 212 at a higher position than the plant. However, the pillar may be damaged in the event of a collision, and may block the view or take up a lot of the layout depending on the installation position thereof.

For this reason, in this embodiment, the growth LED member 212 is mounted below the main body 210 to solve said problems and to allow light to be effectively radiated on the moss 10.

In this sense, the pole member 214 is disposed upright above each of the growth LED members 212 and is made of a transparent material, allowing the light emitted from the growth LED members 212 to be transmitted outwards.

Preferably, so as for the pole member 214 to have a structure in which light is radiated from top to bottom, the pole member 214 may be disposed upright and have a height greater than that of the moss 10.

The reflection plate 216 is mounted at an upper portion of the pole member 214, and is configured to reflect the light transmitted from the pole member 214.

Here, the reflection plate 216 is mounted at the upper portion of the pole member 214 and is inclined upwards, and may be provided as a pair and have inclinations corresponding to each other.

In this structure, the pair of reflection plates 216 is mounted to one pole member 214 by having inclinations, allowing the light transmitted from the pole member 214 to be reflected and evenly distributed to the surrounding area.

As another embodiment, the main body 210 may further include, as illustrated in FIG. 4, a first blocking member 218 and a second blocking member 219.

The first blocking member 218 is coupled to an outer circumferential surface of the pole member 214, wherein the outer circumferential surface excludes the upper portion of the pole member 214 where the reflection plate 216 is mounted.

In other words, the first blocking member 218 is coupled to the pole member 214 by surrounding the outer circumferential surface of the pole member 214, preventing light loss from the growth LED member 212 and allowing light to be stably transmitted to the area where the reflection plate 216 is mounted.

Moreover, the second blocking member 219 is coupled to the rear surface of the reflection plate 216.

The second blocking member 219 is, like the first blocking member 218, to prevent light, emitted from the growth LED member 212 and transmitted from the pole member 214 to the reflection plate 216, from leaking through the rear surface of the reflection plate 216. The second blocking member 219 is also provided as a pair and mounted to the rear surfaces of the pair of reflection plates 216, respectively.

Furthermore, as illustrated in FIG. 5, the front surface of the reflection plate 216 may have an embossed shape. The embossed front surface allows the light transmitted from the pole member 214 to the reflection plate 216 to be reflected at various angles, allowing the moss 10 for generating oxygen to effectively photosynthesize.

As is apparent from the above description, the present disclosure provides the following effects.

According to the present disclosure, provided is an indoor air control apparatus for a vehicle having a structure in which a moss filter, including in the case thereof an intake port configured to intake indoor air, is connected to an HVAC system, including a blower, via a separate connection duct, allowing oxygen generated from the moss filter to be effectively delivered to the interior of the vehicle through the blower when operating in a recirculation mode.

Therefore, according to the present disclosure, oxygen generated from the moss filter may be delivered to the interior of the vehicle using the blower mounted in the HVAC system, simplifying the structure by eliminating a separate blower, thereby reducing manufacturing costs.

In the above, embodiment(s) of the present disclosure have been described with reference to the accompanying drawings. However, those skilled in the art to which the present disclosure pertains will understand that various modifications may be made therefrom, and that all or part of the above-described embodiment(s) may be selectively combined. Therefore, the true technical protection scope of the present disclosure should be determined by the technical ideas of the appended claims.

What is claimed is:

1. An indoor air cleaning apparatus for a vehicle, the apparatus comprising:
a heating, ventilation, and air conditioning (HVAC) module configured to regulate a temperature of indoor and outdoor air, and to provide conditioned air into an interior of the vehicle through a blower; and
a moss filter module, connected to the HVAC module, having air-purifying plants planted therein, and configured to allow oxygen generated therein to flow to the HVAC module as air is introduced thereinto through a plurality of intake ports.

2. The apparatus of claim 1, wherein the plurality of intake ports are configured to be open in a recirculation mode for the HVAC module.

3. The apparatus of claim 1, wherein the moss filter module comprises:
a main body including the plurality of intake ports and having the air-purifying plants disposed thereon; and
a plurality of flow guides mounted in the main body and connected to the intake ports, and configured to guide air generated inside the main body to flow to an inlet of a connection duct provided in the HVAC module.

4. The apparatus of claim 3, wherein the main body is sealed from an outside and is made of a transparent material.

5. The apparatus of claim 3, wherein the main body comprises:
a plurality of growth light emitting diode (LED) members positioned below an area between blocks of the air-purifying plants;
a pole member disposed upright above the growth LED member and configured to transmit light emitted from the growth LED member; and
a reflection plate mounted at an upper portion of the pole member and configured to reflect the light transmitted from the pole member.

6. The apparatus of claim 5, wherein the pole member has a height greater than the air-purifying plants.

7. The apparatus of claim 5, wherein the reflection plate is inclined upwards at the upper portion of the pole member, and wherein the reflection plate comprises a pair of reflection plates each having inclinations corresponding to each other.

8. The apparatus of claim 5, wherein the main body further comprises:
a first blocking member coupled to an outer circumferential surface of the pole member, wherein the outer circumferential surface excludes an area where the reflection plate is mounted; and
a second blocking member coupled to a rear surface of the reflection plate.

9. The apparatus of claim 8, wherein the reflection plate has a front surface configured to reflect the light transmitted from the pole member, and wherein the front surface has an embossed shape.

10. A vehicle comprising the indoor air cleaning apparatus of claim 1.
